(19) United States
(12) Patent Application Publication
(10) Pub. No.: US 2025/0262904 A1
(43) Pub. Date: Aug. 21, 2025

(54) ELECTRONIC CONTROL SHOCK ABSORBER HAVING COAXIAL DUAL SOLENOID VALVES

(71) Applicant: HL Mando Corporation, Pyeongtaek-si (KR)

(72) Inventors: Byeongsang SON, Pyeongtaek-si (KR); Doobyung KIM, Pyeongtaek-si (KR); Mookwon KIM, Pyeongtaek-si (KR); Youngjae KIM, Pyeongtaek-si (KR)

(21) Appl. No.: 19/058,475

(22) Filed: Feb. 20, 2025

(30) Foreign Application Priority Data
Feb. 21, 2024 (KR) 10-2024-0024699

(51) Int. Cl. B60G 17/015; B60G 13/08; B60G 17/0165; B60G 17/08

(52) U.S. Cl. CPC B60G 17/0152; B60G 13/08; B60G 17/0165; B60G 17/08; B60G 2202/24; B60G 2202/414; B60G 2204/62; B60G 2206/41; B60G 2500/104; B60G 2500/114; B60G 2600/182; B60G 2800/162; B60G 2800/916

(57) ABSTRACT

The present disclosure provides an electronic control shock absorber having coaxial dual solenoid valves. The electronic control shock absorber includes a cylinder formed with a double structure having an internal space and an external space, the internal space being divided into a compression chamber and a rebound chamber, and a reservoir chamber being formed in the external space, a compression solenoid valve mounted on an outside of the cylinder, and a rebound solenoid valve mounted on the outside of the cylinder. The compression solenoid valve and the rebound solenoid valve are arranged on the same axis to face each other.

### CROSS-REFERENCE TO RELATED APPLICATION

This application claims the benefit of and priority to Korean Patent Application No. 10-2024-0024699, filed on Feb. 21, 2024, the entire disclosure of which is hereby incorporated herein by reference in its entirety.

### TECHNICAL FIELD

The present disclosure relates to an electronic control shock absorber for vehicles, and more particularly relates to an electronic control shock absorber having coaxial dual solenoid valves.

### BACKGROUND

While a vehicle is driven, the vehicle is constantly exposed to vibrations and shocks from a road surface through wheels. When the vibrations or the shocks transmitted through the wheels are directly transmitted to a vehicle body and a steering wheel, ride comfortability and driving stability may be significantly degraded. In order to alleviate the vibrations or the shocks, the vehicle needs to be equipped with a suspension system. A shock absorber, a spring, and a suspension arm are main components forming a suspension system.

The shock absorber includes a cylinder, a piston rod, a piston valve, and the like. The piston valve is located inside the cylinder in a state of being connected to the piston rod, and generates a damping force.

When the damping force of the shock absorber is set to a weak level, the shock absorber can improve the ride comfortability by absorbing the vibrations generated by uneven portions on the road surface. On the other hand, when the damping force is set to a high level, a posture change in the vehicle body is suppressed, thereby improving steering stability. Therefore, in the related art, it is common to select and apply shock absorbers in which different damping force characteristics are set depending on an intended use of the vehicle.

Recently, a damping force variable shock absorber has been developed as follows. A variable damping force valve which can appropriately adjust the damping force characteristics of the shock absorber is mounted on the shock absorber. In this manner, the damping force characteristics can be appropriately adjusted depending on the road surface and driving conditions by installing.

However, in the related art, according to an electronic control shock absorber on which the coaxial dual solenoid valves are mounted, two solenoid valves are arranged in series in an axial direction of the shock absorber. Consequently, there is a problem in that a mounting space is less likely to be secured. That is, in a situation where there is an increasing market demand for the electronic control shock absorber of the dual solenoid type, there is a problem in that an application of the coaxial dual solenoid valves to vehicles is limited due to a structural limitation.

In particular, in a case of a vehicle to which an air spring is applied, it is more difficult to apply the coaxial dual solenoid valves to the vehicle due to interference with the air spring. In addition, according to the electronic control shock absorber of the dual solenoid type in the related art, a separately processed housing block is welded to an outer tube to combine the dual solenoids. However, there is a disadvantage in that two separate upper and lower tubes need to be individually welded to form chambers separated by each stroke.

In addition, referring to FIG. 6, assembly work is complicated in that the solenoid valve needs to be sealed with an O-ring 20 when the solenoid valve is fastened to a separation tube 15. KR10-2023-0068294A is an example of the related art.

### SUMMARY

The present disclosure is devised to solve the above-described problems in the related art, and aims to provide a new arrangement structure of coaxial dual solenoid valves in which an electronic control shock absorber to which the coaxial dual solenoid valves are applied is more freely mounted.

In addition, the present disclosure aims to provide a structure in which the coaxial dual solenoid valves are simply assembled.

According to one embodiment of the present disclosure, in order to solve the above-described problems, there is provided an electronic control shock absorber having coaxial dual solenoid valves. The electronic control shock absorber includes a cylinder formed with a double structure having an internal space and an external space, the internal space being divided into a compression chamber and a rebound chamber, and a reservoir chamber being formed in the external space, a compression solenoid valve mounted on an outside of the cylinder, and a rebound solenoid valve mounted on the outside of the cylinder. The compression solenoid valve and the rebound solenoid valve are arranged on the same axis to face each other.

In addition, the compression solenoid valve and the rebound solenoid valve may be located at the same height in an axial direction of the cylinder.

In addition, each of the compression solenoid valve and the rebound solenoid valve may be connected to a separation tube inside the cylinder.

In addition, the cylinder may include a base shell arranged on an outermost side, and an inner tube arranged on an innermost side, the rebound chamber may be formed in an upper portion inside the inner tube, the compression chamber may be formed in a lower portion inside the inner tube, and the separation tube may be arranged between the inner tube and the base shell.

In addition, the rebound solenoid valve may be connected to the separation tube by a rebound inner sleeve mounted on the separation tube.

In addition, the compression solenoid valve may be connected to the separation tube by a compression inner sleeve mounted on the separation tube.

In addition, the compression inner sleeve may include a first opening open outward in a radial direction to communicate with the compression solenoid valve, and a second opening open downward of the separation tube.

In addition, the rebound inner sleeve may include a third opening open outward in the radial direction to communicate with the rebound solenoid valve, and a fourth opening open upward of the separation tube.

In addition, during a compression stroke, as a piston valve descends, a fluid inside the compression chamber may flow into the separation tube after passing through a first communication hole formed in a lower portion of the inner tube.

In addition, the fluid flowing into the separation tube may ascend and flow into the second opening of the compression inner sleeve.

In addition, the fluid flowing into the second opening of the compression inner sleeve may be discharged through the first opening open outward in the radial direction.

In addition, the discharged fluid may be discharged to the reservoir chamber after flowing into the compression solenoid valve.

In addition, during a rebound stroke, as the piston valve ascends, the fluid inside the rebound chamber may flow into the upper separation tube after passing through a second communication hole formed in an upper portion of the inner tube.

In addition, the fluid flowing into the separation tube may descend and flow into the fourth opening of the rebound inner sleeve.

In addition, the fluid flowing into the fourth opening may be discharged through the third opening open outward in the radial direction.

In addition, the discharged fluid may be discharged to the reservoir chamber after flowing into the rebound solenoid valve.

In addition, according to another embodiment of the present disclosure, there is provided an electronic control shock absorber having coaxial dual solenoid valves. The electronic control shock absorber includes a cylinder formed with a double structure having an internal space and an external space, the internal space being divided into a compression chamber and a rebound chamber, and a reservoir chamber being formed in the external space, a compression solenoid valve mounted on an outside of the cylinder, and a rebound solenoid valve mounted on the outside of the cylinder. The compression solenoid valve and the rebound solenoid valve are arranged on the same axis.

In addition, the compression solenoid valve may be fastened to the cylinder by the compression inner sleeve mounted on the separation tube inside the cylinder, may be compressed against the inner sleeve, and may be fastened by metal sealing.

In addition, a protrusion portion convexly protruded may be formed in an end portion of a compression port of the compression solenoid valve, and the metal sealing may be performed in such a manner that the protrusion portion is brought into contact with and compressed against a facing surface facing the protrusion portion in the compression inner sleeve.

In addition, the rebound solenoid valve may be fastened to the cylinder by the rebound inner sleeve mounted on the separation tube inside the cylinder, and may be fastened by the rebound inner sleeve and an O-ring.

In the electronic control shock absorber having the coaxial dual solenoid valves according to the present disclosure configured as described above, the coaxial dual solenoid valves are arranged on the same axis to avoid interference with other components when mounted. Therefore, there is an advantageous effect in that the electronic control shock absorber is more freely mounted.

In addition, there is an advantageous effect in that the coaxial dual solenoid valves are applicable to vehicles to which an air suspension is applied without interference with the air suspension located at an upper portion of the valves.

In addition, the solenoid valves are fastened by using the internally mounted inner sleeve without using a housing block. Therefore, there is an advantageous effect in that simple fastening is available.

In addition, the compression solenoid valve is fastened to the inner sleeve inside the cylinder by the metal sealing. Therefore, there is an advantageous effect in that simple fastening is available without using the O-ring.

### BRIEF DESCRIPTION OF THE DRAWINGS

FIGS. 1 to 6 are diagrams for describing an operation of a working fluid of an electronic control shock absorber having coaxial dual solenoid valves of the present disclosure.

FIGS. 1 to 3 are diagrams for describing a flow of the fluid during a compression stroke in the electronic control shock absorber having the coaxial dual solenoid valves of the present disclosure.

FIGS. 4 and 5 are diagrams for describing a flow of the fluid during a rebound stroke in the electronic control shock absorber to which the coaxial dual solenoid valves of the present disclosure are applied.

FIG. 6 is a diagram showing a state where a solenoid valve of the present disclosure is fastened to a separation tube after being sealed with an O-ring.

FIG. 7 is a diagram showing a structure of the electronic control shock absorber having the coaxial dual solenoid valves according to one embodiment of the present disclosure.

FIG. 8 is a partially enlarged view of a compression solenoid valve side in the electronic control shock absorber in FIG. 7.

FIG. 9 is a partially enlarged view showing a state where the compression solenoid valve is fastened by metal sealing in the electronic control shock absorber in FIG. 7.

FIG. 10 is a partially enlarged view of a rebound solenoid valve side in the electronic control shock absorber in FIG. 7.

FIG. 11 is a diagram showing a flow of the fluid during the compression stroke in the electronic control shock absorber in FIG. 7.

FIG. 12 is a diagram showing a flow of the fluid during the rebound stroke in the electronic control shock absorber in FIG. 7.

### DETAILED DESCRIPTION

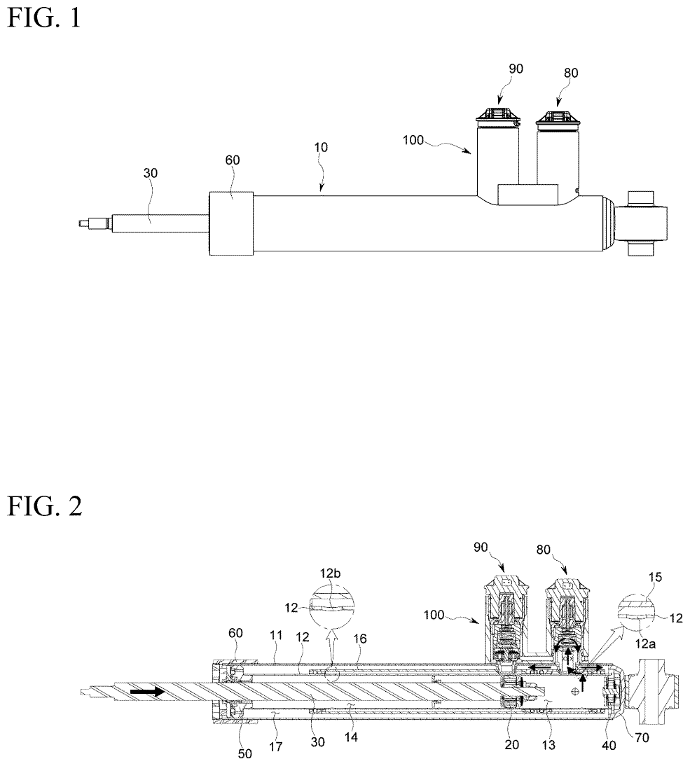

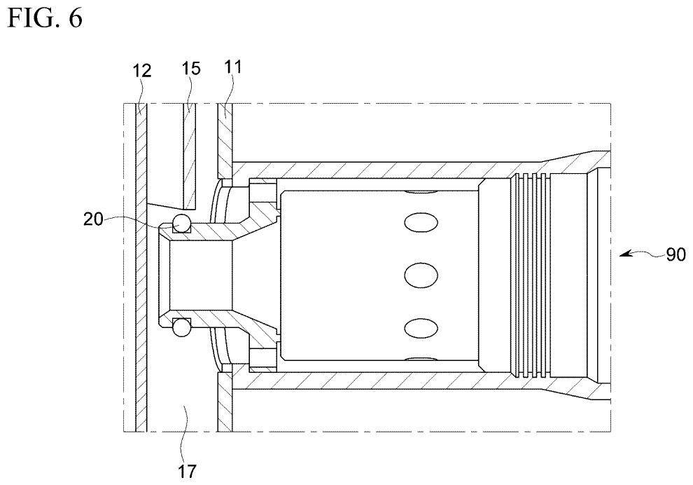

Hereinafter, referring to FIGS. 1 to 6, a flow route of a working fluid during compression and rebound strokes of coaxial dual solenoid valves according to one embodiment of the present disclosure will be described. FIGS. 1 to 6 are diagrams for facilitating understanding of the flow route of the working fluid inside a damping force variable shock absorber according to one embodiment of the present disclosure, and do not directly reflect an arrangement and a structure of components of the damping force variable shock absorber of the present disclosure.

Referring to FIG. 1, the damping force variable shock absorber of the present disclosure includes a rebound solenoid valve 90 for adjusting a damping force during a rebound stroke, and a compression solenoid valve 80 for adjusting a damping force during a compression stroke. An internal space of a cylinder forming a shock absorber is divided into a compression chamber and a rebound chamber by a piston valve, and each of the chambers is filled with a fluid such as oil.

During the compression stroke, the piston valve pressurizes the fluid inside the compression chamber. In this manner, the compression chamber is brought into a high pressure state, and the rebound chamber is brought into a relatively low pressure state. During the rebound stroke, the piston valve pressurizes the fluid inside the rebound chamber. In this manner, the rebound chamber is brought into the high pressure state, and the compression chamber is brought into the relatively low pressure state.

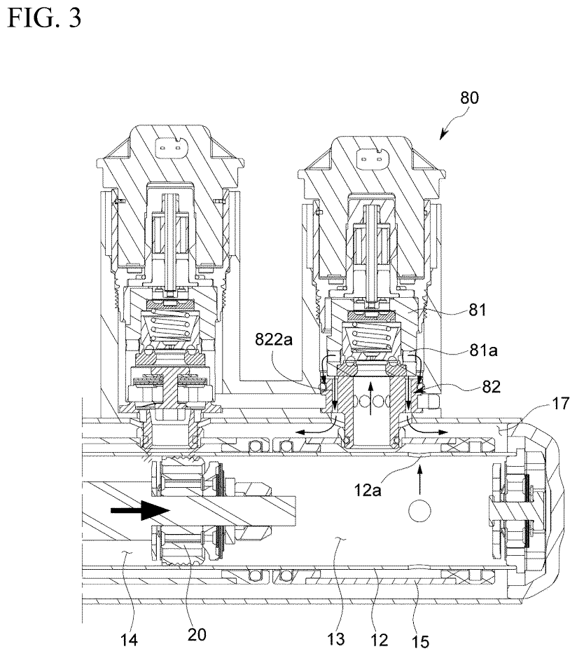

During the compression stroke in FIGS. 2 and 3, the fluid inside a compression chamber 13 flows into a compression separation tube 15, and moves to a reservoir chamber 17 through a compression solenoid valve 80. Some of the fluid moves to a rebound chamber 14 through a bypass flow path of a piston valve.

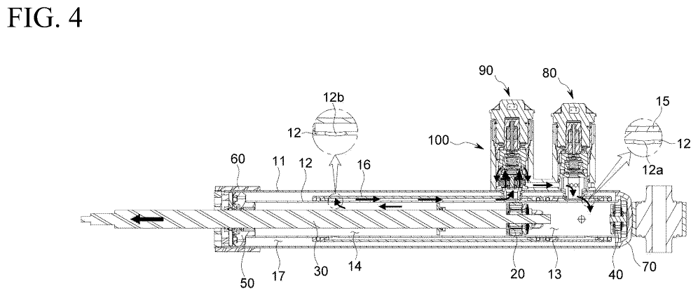

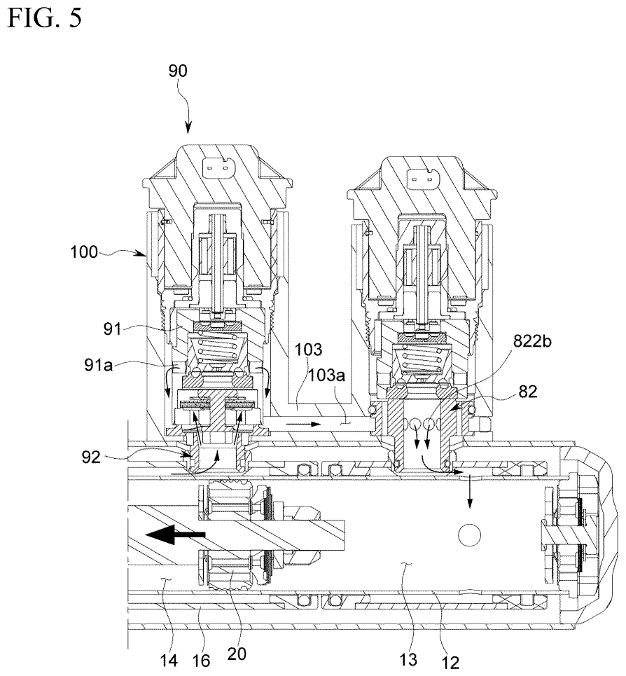

During the rebound stroke in FIGS. 4 and 5, the fluid inside the rebound chamber 14 flows into a rebound separation tube 16, passes through a rebound solenoid valve 90 and a communication hole 103a of a connection portion 103, and moves into a compression chamber 13 through the compression solenoid valve 80. Some of the fluid moves to the compression chamber 13 through a bypass flow path of the piston valve.

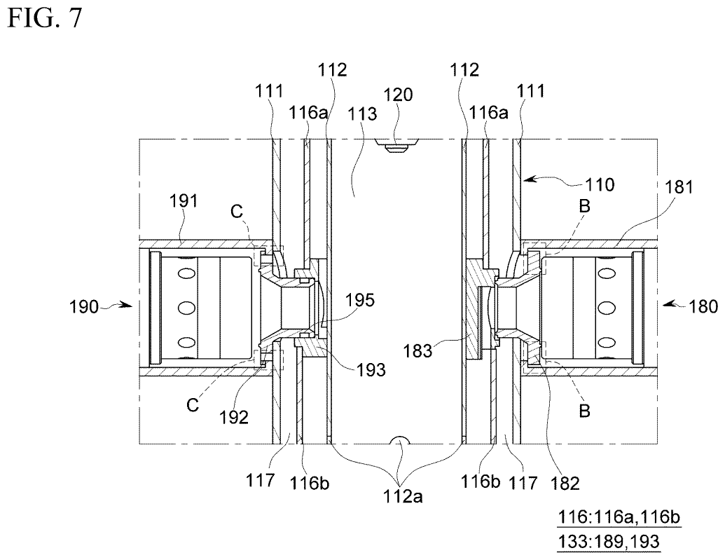

Hereinafter, an electronic control shock absorber having coaxial dual solenoid valves according to the present disclosure will be described in detail with reference to FIGS. 7 to 12.

FIG. 7 shows a structure of the electronic control shock absorber having the coaxial dual solenoid valves according to one embodiment of the present disclosure.

The electronic control shock absorber according to one embodiment of the present disclosure includes a cylinder 110, a piston valve 120, a piston rod (not shown), a body valve (not shown), a compression solenoid valve 180, and a rebound solenoid valve 190.

The compression solenoid valve 180 and the rebound solenoid valve 190 are arranged on a central axis of the solenoid valves without being arranged in series in an axial direction of the cylinder 110 of the shock absorber. In other words, the compression solenoid valve 180 and the rebound solenoid valve 190 are arranged on the same axis, and are arranged at the same height to face each other around the cylinder.

In this way, since the coaxial dual solenoid valves are arranged on the same axis, interference with other components may be avoided when mounted. Accordingly, the coaxial dual solenoid valves may be more freely mounted. In particular, the coaxial dual solenoid valves may be applied to vehicles to which an air suspension is applied without interference with the air suspension located at an upper portion of the valves.

Each of the compression solenoid valve 180 and the rebound solenoid valve 190 is connected to a separation tube 116 inside the cylinder 110.

Hereinafter, referring to FIG. 7, a structure in which the compression solenoid valve 180 and the rebound solenoid valve 190 are connected to the separation tube 116 will be described in detail.

The cylinder 110 includes a base shell 111 on an outermost side, and an inner tube 112 on an innermost side. The inside of the inner tube 112 is formed by the piston valve 120 to separately form the rebound chamber in an upper portion and the compression chamber in a lower portion. The separation tube 116 is located between the inner tube 112 and the base shell 111.

The rebound solenoid valve 190 is connected to the separation tube 116 through a rebound inner sleeve 193.

The compression solenoid valve 180 includes a compression valve housing 181 and a compression port 182 connected to one end of the compression valve housing 181. The compression port 182 is connected to the compression inner sleeve 183, and the compression solenoid valve 180 is ultimately connected to the separation tube 116.

The rebound solenoid valve 190 includes a rebound valve housing 191 and a rebound port 192 connected to one end of the rebound valve housing 191. The rebound port 192 is connected to the rebound inner sleeve 193, and the rebound solenoid valve 190 is ultimately connected to the separation tube 116.

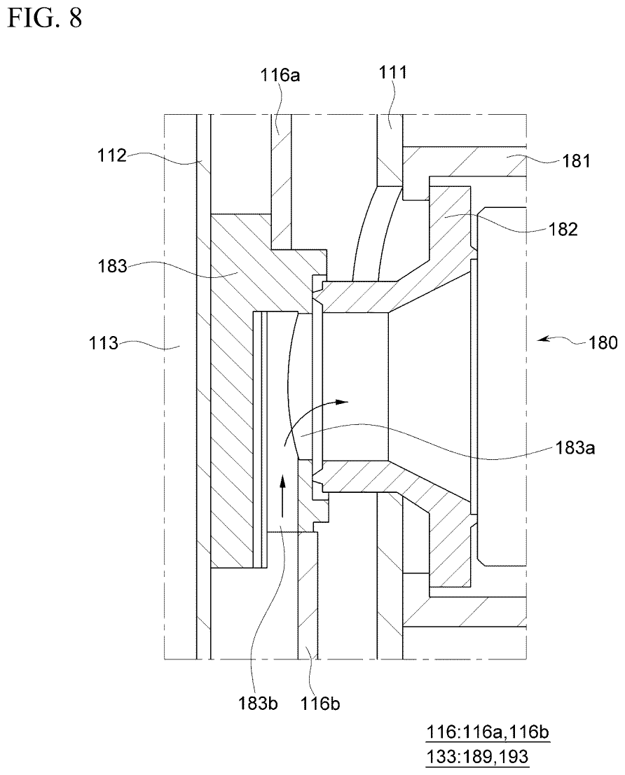

Referring to FIG. 8, a structure of the compression inner sleeve 183 will be described.

The compression inner sleeve 183 includes a first opening 183a connected to the compression port 182, and open in a radial direction to communicate with the compression port 182, and a second opening 183b open downward of the separation tube 116.

The fluid inside the separation tube 116 flows into the second opening 183b, and is discharged through the first opening 183a.

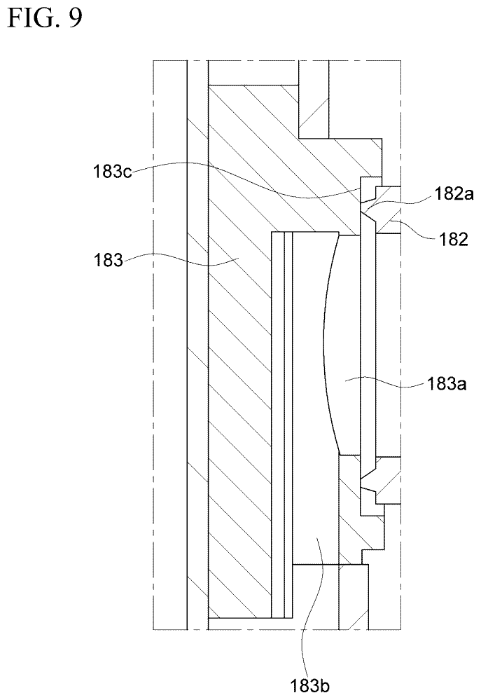

FIG. 9 shows a state where the compression solenoid valve 180 is fastened by metal sealing. A protrusion portion 182a protruded convexly is formed in an end portion of the compression port 182 of the compression solenoid valve 180. The protrusion portion 182a is brought into contact with and compressed against a facing surface 183c facing the protrusion portion 182a in the compression inner sleeve 183. In this manner, sealing is performed. Since the compression port 182 and the compression inner sleeve 183 are made of a metal material, compression sealing is available. This sealing is referred to as metal sealing. Compared to sealing using an O-ring, the metal sealing enables simple sealing without requiring an additional component such as the O-ring.

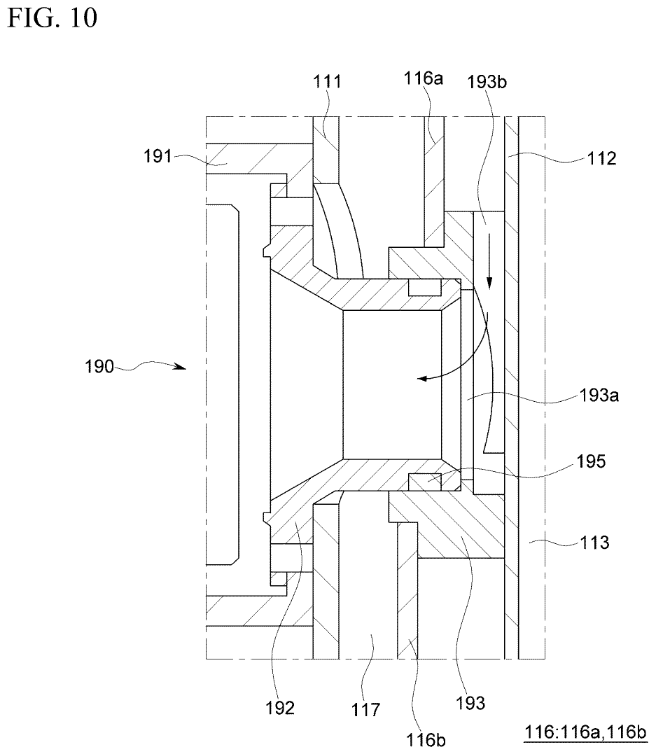

FIG. 10 is a partially enlarged view of the rebound solenoid valve 190. Referring to FIG. 10, the rebound inner sleeve 193 includes a third opening 193a connected to the rebound port 192 and open in the radial direction to communicate with the rebound port 192, and a fourth opening 193b open upward of the separation tube 116.

The fluid inside the separation tube 116 flows into the fourth opening 193b, and is discharged through the third opening 193a.

In a state where an end of the rebound port 191 of the rebound solenoid valve 190 is inserted into the third opening 193a of the rebound inner sleeve 193, an inner peripheral surface of the third opening 193a and an outer peripheral surface of the rebound port 191 are fastened by an O-ring 195.

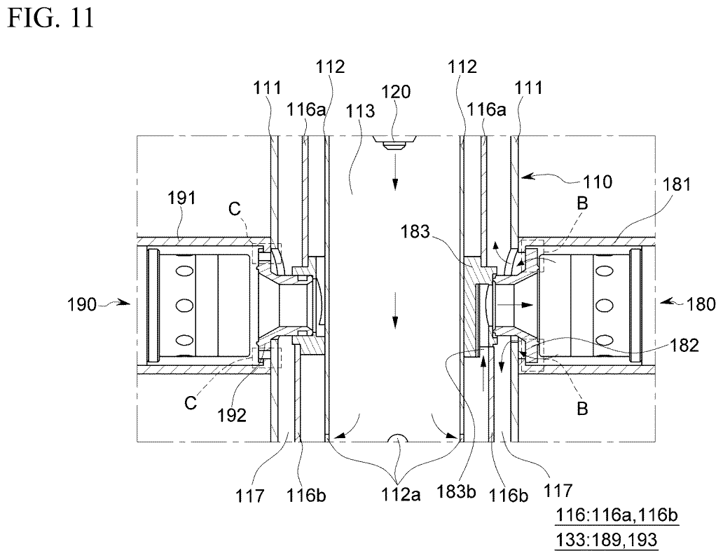

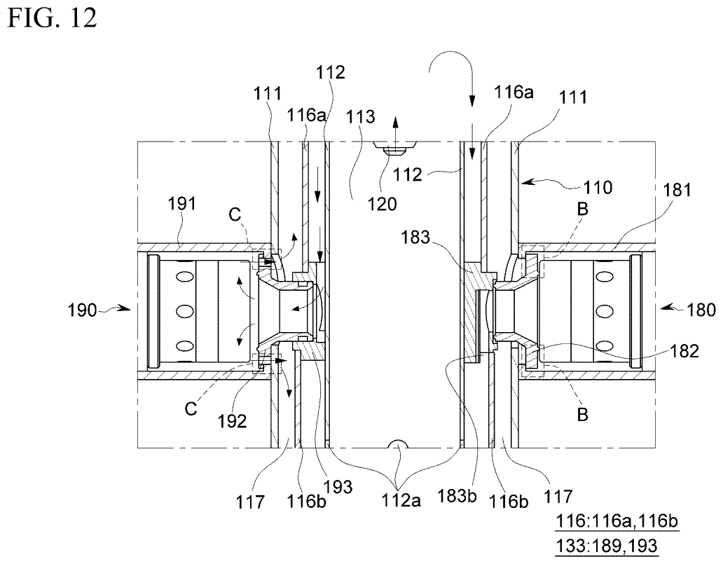

Hereinafter, a flow of a fluid during the compression stroke and the rebound stroke will be described with reference to FIGS. 11 and 12.

Referring to FIG. 11, during the compression stroke, as the piston valve 120 descends, the fluid inside the compression chamber 113 flows into the separation tube 116 after passing through a first communication hole 112a formed in a lower portion of the inner tube 112. The fluid flowing into the separation tube 116 ascends and flows into the second opening 183b of the compression inner sleeve 183, and is discharged through the first opening 183a open outward in the radial direction. The discharged fluid is discharged to the reservoir chamber 117 after flowing into the compression solenoid valve 180 through the compression port 182. Referring to FIG. 12, during the rebound stroke, as the piston valve 120 ascends, the fluid inside the rebound chamber flows into the separation tube 116 in the upper portion after passing through a second communication hole (not shown) formed in an upper portion of the inner tube 112. The fluid flowing into the separation tube 116 descends and flows into a fourth opening 194b of the rebound inner sleeve 193, and is discharged through a third opening 194a open outward in the radial direction. The discharged fluid is discharged to the reservoir chamber 117 after flowing into the rebound solenoid valve 190 through the rebound port 192.

The above-described configuration is only an example of the technical idea of the present disclosure, and those skilled in the art to which the present disclosure belongs may perform various corrections, modifications, and substitutions within the scope not departing from the essential characteristics of the present disclosure. Therefore, the present embodiment is provided to describe the technical idea of the present disclosure without being intended to limit the technical idea of the present disclosure. The scope of the technical idea of the present disclosure is not limited by the embodiment. The protection scope of the present disclosure should be interpreted by the appended claims, and all technical ideas within the scope equivalent thereto should be interpreted as being included in the scope of the rights of the present disclosure.

### DETAILED DESCRIPTION OF MAIN ELEMENTS

110 cylinder
111 base shell
112 inner tube
113 compression chamber
116 separation tube
117 reservoir chamber
120 piston valve
180 compression solenoid valve
181 compression valve housing
182 compression port
182a protrusion portion
183 compression inner sleeve
183a first opening
183b second opening
183c facing surface
190 rebound solenoid valve
191 rebound valve housing
192 rebound port
193 rebound inner sleeve
193a third opening
193b fourth opening
195 O-ring
112a first communication hole

What is claimed is:

1. An electronic control shock absorber having coaxial dual solenoid valves, comprising:
a cylinder formed with a double structure having an internal space and an external space, the internal space being divided into a compression chamber and a rebound chamber, and a reservoir chamber being formed in the external space;
a compression solenoid valve mounted on an outside of the cylinder; and
a rebound solenoid valve mounted on the outside of the cylinder,
wherein the compression solenoid valve and the rebound solenoid valve are arranged on the same axis to face each other.

2. The electronic control shock absorber having coaxial dual solenoid valves of claim 1, wherein the compression solenoid valve and the rebound solenoid valve are located at the same height in an axial direction of the cylinder.

3. The electronic control shock absorber having coaxial dual solenoid valves of claim 2, wherein each of the compression solenoid valve and the rebound solenoid valve is connected to a separation tube inside the cylinder.

4. The electronic control shock absorber having coaxial dual solenoid valves of claim 3, wherein the cylinder includes a base shell arranged on an outermost side, and an inner tube arranged on an innermost side, the rebound chamber is formed in an upper portion inside the inner tube, the compression chamber is formed in a lower portion inside the inner tube, and the separation tube is arranged between the inner tube and the base shell.

5. The electronic control shock absorber having coaxial dual solenoid valves of claim 4, wherein the rebound solenoid valve is connected to the separation tube by a rebound inner sleeve mounted on the separation tube.

6. The electronic control shock absorber having coaxial dual solenoid valves of claim 5, wherein the compression solenoid valve is connected to the separation tube by a compression inner sleeve mounted on the separation tube.

7. The electronic control shock absorber having coaxial dual solenoid valves of claim 6, wherein the compression inner sleeve includes a first opening open outward in a radial direction to communicate with the compression solenoid valve, and a second opening open downward of the separation tube.

8. The electronic control shock absorber having coaxial dual solenoid valves of claim 7, wherein the rebound inner sleeve includes a third opening open outward in the radial direction to communicate with the rebound solenoid valve, and a fourth opening open upward of the separation tube.

9. The electronic control shock absorber having coaxial dual solenoid valves of claim 8, wherein during a compression stroke, as a piston valve descends, a fluid inside the compression chamber flows into the separation tube after passing through a first communication hole formed in a lower portion of the inner tube.

10. The electronic control shock absorber having coaxial dual solenoid valves of claim 9, wherein the fluid flowing into the separation tube ascends and flows into the second opening of the compression inner sleeve.

11. The electronic control shock absorber having coaxial dual solenoid valves of claim 10, wherein the fluid flowing into the second opening of the compression inner sleeve is discharged through the first opening open outward in the radial direction.

12. The electronic control shock absorber having coaxial dual solenoid valves of claim 11, wherein the discharged fluid is discharged to the reservoir chamber after flowing into the compression solenoid valve.

13. The electronic control shock absorber having coaxial dual solenoid valves of claim 8, wherein during a rebound stroke, as the piston valve ascends, the fluid inside the rebound chamber flows into the upper separation tube after passing through a second communication hole formed in an upper portion of the inner tube.

14. The electronic control shock absorber having coaxial dual solenoid valves of claim 13, wherein the fluid flowing into the separation tube descends and flows into the fourth opening of the rebound inner sleeve.

15. The electronic control shock absorber having coaxial dual solenoid valves of claim 14, wherein the fluid flowing into the fourth opening is discharged through the third opening open outward in the radial direction.

16. The electronic control shock absorber having coaxial dual solenoid valves of claim 15, wherein the discharged fluid is discharged to the reservoir chamber after flowing into the rebound solenoid valve.

17. The electronic control shock absorber having coaxial dual solenoid valves of claim 1, wherein the compression solenoid valve is fastened to the cylinder by the compression inner sleeve mounted on the separation tube inside the cylinder, is compressed against the inner sleeve, and is fastened by metal sealing.

18. The electronic control shock absorber having coaxial dual solenoid valves of claim 17, wherein a protrusion portion convexly protruded is formed in an end portion of a compression port of the compression solenoid valve, and the metal sealing is performed in such a manner that the protrusion portion is brought into contact with and compressed against a facing surface facing the protrusion portion in the compression inner sleeve.
